(19) United States
(12) Patent Application Publication
(10) Pub. No.: US 2004/0238671 A1
(43) Pub. Date: Dec. 2, 2004

(54) Magnetic tape guide and method of use

(76) Inventors: Jerome D. Brown, Wahpeton, ND (US); Michael A. Mewes, Fargo, ND (US); James L. Albrecht, Wahpeton, ND (US); Geoffrey A. Lauinger, Campbell, MO (US); Christopher J. Zwettler, Lake Elmo, MO (US)

Correspondence Address: Imation Corp., PO Box 64898, St. Paul, MN, 55164-0898, US

(21) Appl. No.: 10/452,757

(22) Filed: Jun. 2, 2003

(51) Int. Cl. G11B 23/107

(52) U.S. Cl. 242/348

(57) ABSTRACT

A tape guide for use in a tape transport system, such as a data storage tape cartridge or a tape drive. The storage tape extends from the tape reel along a tape path that includes the tape guide. In this regard, the tape guide includes a tape contact face and at least one guide flange. Extension of the guide flange relative to the tape contact face defines an angle of not less than 90°. With this configuration, an edge of the storage tape is directed to move along the guide flange with lateral tape movement so as to minimize the opportunity for micro-buckling. In one preferred embodiment, a portion of the guide flange is curved.

### BACKGROUND OF THE INVENTION

The present invention relates to the guidance of a magnetic storage tape within a tape transport system including, for example, a data storage tape cartridge and a tape drive having a read/write head. More particularly, it relates to tape guides useful in controlling lateral tape movement or position with minimal edge wear.

Tape guides are employed to define a desired tape path within various tape transport system such as data storage tape cartridges, tape drives, etc. To this end, data storage tape cartridges have been used for decades in the computer, audio, and video fields. Due to their low cost and high storage capacity, data storage tape cartridges continue to be an extremely popular form of recording large volumes of information for subsequent retrieval and use in conjunction with a tape drive system including a read/write head.

Data storage tape cartridges generally consist of an outer shell or housing maintaining at least one tape reel and a length of magnetic storage tape. The storage tape is wrapped about a hub portion of the tape reel and is driven through a defined path by a driving system. The housing normally includes a separate cover and base, the combination of which forms an opening (or window) at a forward portion thereof for allowing access to the storage tape by a read/write head of the tape drive. This interaction between storage tape and head may take place within the housing (for example, with a mid-tape load design), or the storage tape may be directed away from the housing to an adjacent area at which the read/write head is located (for example, with a helical drive design or a leader block design). Where the tape cartridge/drive system is designed to direct the storage tape away from the housing, the data storage tape cartridge normally includes a single tape reel. Conversely, where the tape cartridge/drive system is designed to provide head/storage tape interaction within or very near the housing, a two- or dual-tape reel configuration is typically employed.

With either single or dual reel configurations, a common concern is lateral positioning of the storage tape relative to the read/write head. In particular, it is common practice to write data onto, and read data from, the storage tape in rows, or tracks, running in the longitudinal, or tape transport, direction. That is to say, the tape is driven in a longitudinal fashion relative to the read/write head. Undesired lateral (or edge-to-edge) motion may be created in the storage tape as part of this longitudinal movement. For example, the storage tape extends from a tape reel associated with the tape cartridge along a tape path that allows interface between the read/write head and the storage tape. With a single reel cartridge design, the tape drive includes a take-up reel, with the storage tape extending from the cartridge reel to the drive reel. Alternatively, with a dual-reel cartridge design, the storage tape extends between the two cartridge reels. Regardless, the typical tape reel includes a central hub and opposing flanges. The storage tape is wrapped about the central hub and is laterally constrained by the hub flanges (i.e., the hub flanges limit lateral movement of the storage tape by contacting a respective top or bottom edge of the tape). However, to avoid wear of the storage tape edges, a slight opening taper to the hub flanges is provided. Thus, an overall lateral spacing between the opposing hub flanges is greater than a width of the storage tape, typically on the order of 0.002-0.020 inch. As a result, during tape reel rotation, the storage tape may move laterally from flange to flange by as much as 250 micrometers. If left uncorrected, this lateral movement may lead to track following problems and/or read/write errors.

An accepted technique for controlling lateral tape movement includes providing one or more tape guides along the tape path. The tape guide can assume a variety of shapes or forms, and can be located within the cartridge, within the drive, or both. In general terms, the tape guide provides a tape contact (or bearing) face and at least one guide flange extending from the tape contact face along a side thereof Typically, two tape guide flanges are provided, extending from opposite sides of the tape contact face. Regardless, the tape contact face is laterally planar and longitudinally curved for dictating a desired tape path. The tape guide flange(s) extend perpendicular to the lateral plane of the tape contact face, such that a 90° corner is defined by the tape guide flange and the tape contact face. With this configuration, if the tape moves in a lateral fashion along the tape contact face, an edge of the tape will contact the tape guide flange. Interface between the tape edge and the tape guide flange, in turn, “forces” the storage tape to move in a laterally opposite direction, thereby preventing overt lateral movement.

While the above-described guide design is well accepted, certain concerns have been identified. In particular, interface between the tape guide flange and the storage tape may cause the tape edge to wear over time. For example, FIG. 1 schematically depicts a portion of a prior art tape guide 10 in conjunction with a storage tape 12. The tape guide 10 includes a tape contact face 14 and a guide flange 16. The guide flange 16 extends at a 90° (or right) angle relative to the tape contact face 14. The storage tape 12 includes a back side 18 that is guided along the tape contact face 14 in a longitudinal fashion (i.e., into and out of the page of FIG. 1), and includes an edge 20. As the storage tape 12 moves laterally relative to the tape contact face 14, the edge 20 contacts the guide flange 16. In some instances, this interface, in conjunction with continued lateral movement, causes the storage tape 12 to buckle (or micro-buckle) at the edge 20 as shown in FIG. 1. In many cases, micro-buckling results in poor tracking performance and/or tape durability issues.

The above-described “inward” movement of the tape edge 20 (i.e., toward the tape contact face 14) via interface with the guide flange 16 is likely due to the composite structure of the storage tape 12. In general terms, the storage tape 12 consists of a base layer with magnetic coating on a front side 22 and a back side coating defining the back side 18. The front side coating and the back side coating have different material properties. When the storage tape 12 is wrapped about a longitudinally curved or circular tape contact face 14, the bias toward the “in” direction is even greater due to the tape tension otherwise pulling the storage tape 12 inward. Compliant guide flange configurations have been suggested to address the above-described tape edge wear concerns. However, compliant guides are relatively expensive, may not provide consistent storage tape interface, and act directly on the tape edge, such that edge wear concerns remain.

While the evolution of tape transport systems, including cartridge and tape drive components, has greatly improved performance, other concerns, including lateral tape movement, remain. As magnetic storage tapes continue to become thinner, contain higher track densities on increasingly narrow tracks, and travel at elevated speeds, the above-described edge wear and tracking performance concerns will become more evident. Therefore, a need exists for a tape guide for use in a tape transport system configured to control lateral tape movement with minimal edge wear.

### SUMMARY OF THE INVENTION

One aspect of the present invention relates to a data storage tape cartridge including a housing, at least one tape reel, a storage tape, and a tape guide. The tape reel is rotatably disposed within the housing. The storage tape extends from the tape reel along a tape path. Finally, the tape guide is positioned within the housing and defines a portion of the tape path. In this regard, the tape guide includes a tape contact face and at least one guide flange. Extension of the flange relative to the tape contact face defines an angle of not less than 90°. With this configuration, if the storage tape moves laterally along the tape contact face, an edge of the storage tape is directed to ride along the guide flange to minimize the opportunity for micro-buckling. In one preferred embodiment, a portion of the guide flange is curved to promote uniform lateral transitioning or movement of the storage tape along the guide flange.

Another aspect of the present invention relates to a method of guiding a storage tape in a tape transport system. In this regard, the storage tape includes a front side, a back side, and opposing edges. With this in mind, the method includes extending the storage tape from a tape reel along a tape path defined in part by a tape guide having a tape contact face and a top guide flange. The storage tape is driven in a longitudinal fashion along a tape contact face, and is potentially subjected to a lateral motion-causing force. Finally, one of the edges of the storage tape is directed to move away from the tape contact face with lateral movement of the storage tape via interaction with the top guide flange. With this technique, micro-buckling of the storage tape is avoided.

Yet another aspect of the present invention relates to a tape guide for use in a tape transport system. The tape guide includes a tape contact face and at least one guide flange. The guide flange extends from one side of the tape contact face, with an extension of the guide flange relative to the tape contact face defining an angle of not less than 90°. The tape guide can be positioned within a data storage tape cartridge or within a tape drive.

### BRIEF DESCRIPTION OF THE DRAWINGS

FIG. 1 is a cross-sectional view of a portion of a prior art tape guide in conjunction with a storage tape;

FIG. 2 is a perspective view of an exemplary data storage tape cartridge;

FIG. 3 is a top view of the data storage tape cartridge of FIG. 2 with the housing removed;

FIG. 4 is a perspective view of a tape guide portion of the cartridge of FIG. 3;

FIG. 5A is a cross-sectional view of a portion of the tape guide of FIG. 4;

FIG. 5B is a cross-sectional view of the tape guide of FIG. 5A in conjunction with a storage tape;

FIG. 5C is a cross-sectional view of a portion of an alternative embodiment tape guide;

FIG. 6 is a perspective view of an alternative embodiment tape guide in accordance with the present invention;

FIG. 7A is a perspective view of a portion of a data storage tape cartridge including an alternative embodiment tape guide in accordance with the present invention;

FIG. 7B is an enlarged, perspective view of a portion of the data storage tape cartridge of FIG. 7A;

FIG. 8 is a top view of a portion of a data storage tape cartridge incorporating an idler tape guide in accordance with the present invention;

FIG. 9A is an enlarged, perspective view of the idler tape guide of FIG. 8;

FIG. 9B is a cross-sectional view of the idler tape guide of FIG. 9A in conjunction with a storage tape; and

FIG. 9C is an enlarged, cross-sectional view of a portion of an alternative embodiment idler tape guide in accordance with the present invention in conjunction with a storage tape.

### DETAILED DESCRIPTION OF THE PREFERRED EMBODIMENTS

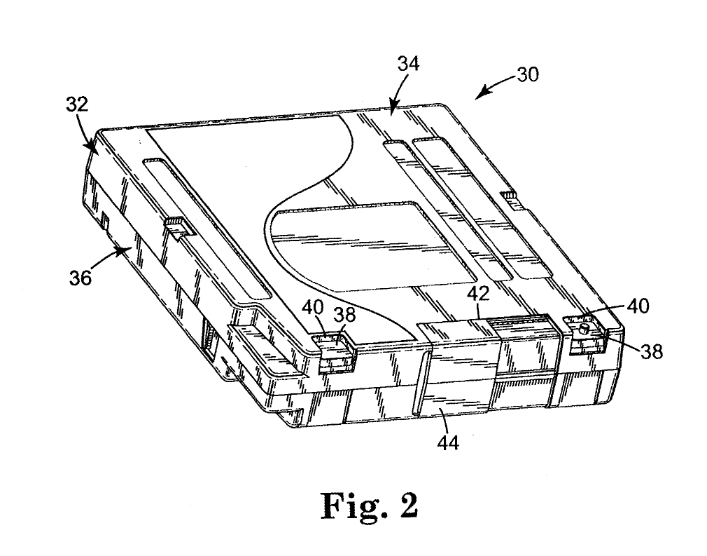

One embodiment of an exemplary data storage tape cartridge 30 is shown in FIG. 2. Generally speaking, the data storage tape cartridge 30 includes a housing 32 defined by a first housing section 34 and a second housing section 36. The data storage tape cartridge 30 further includes a base plate 38, a portion of which is exposed through recesses 40 in the first housing section 34. Remaining components of the data storage tape cartridge 30 are described in greater detail below. However, with reference to FIG. 2, it should be understood that the first housing section 34 and the second housing section 36 are reciprocally mated to one another and form an enclosure within which the various other components, including the base plate 38, are maintained. The housing 32 is preferably sized to be received by a typical tape drive (not shown). Thus, the housing 32 may be sized for use with a 5.25 inch (130 mm) form factor drive, a 3.5 inch (90 mm) form factor drive, or other useful sizes. Further, the first housing section 34 and the second housing section 36 combine to define a head access window 42 through which storage tape (not shown), otherwise maintained within the housing 32, can be accessed by a read/write head (not shown). To this end, the data storage tape cartridge 30 preferably includes a door 44 that is slidably secured to the housing 32 to selectively expose the head access window 42.

In a preferred embodiment, the first housing section 34 defines a cover, and the second housing section 36 defines a base. With reference to the orientation shown in FIG. 2, the data storage tape cartridge 30 is normally inserted into a drive (not shown) with the cover 34 facing upward. It should be recognized, however, that the data storage tape cartridge 30 can be oriented to other positions. Further, the design of the data storage tape cartridge 30 can be such that the first housing section 34 forms a base, with the second housing section 36 being a cover.

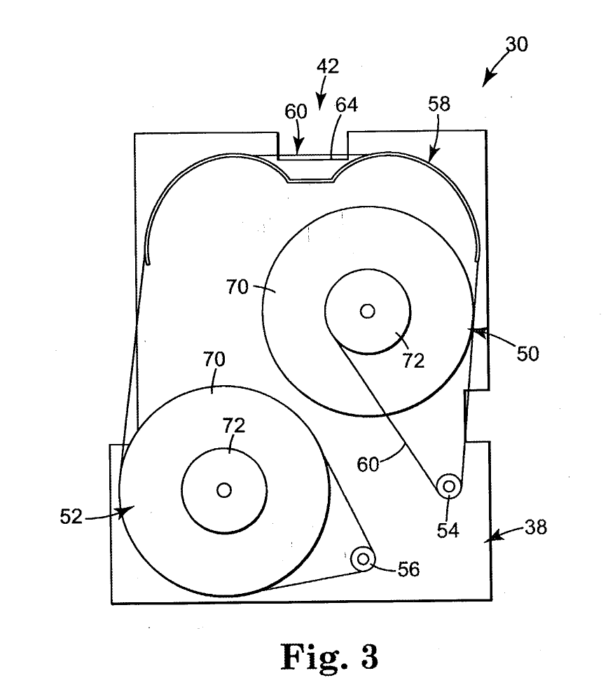

Internal components of one preferred embodiment of the data storage tape cartridge 30 are shown in FIG. 3. Notably, for ease of illustration, the first and second housing sections 34, 36 (FIG. 2) are removed from the view of FIG. 3. With this in mind, the data storage tape cartridge 30 preferably includes the base plate 38, a first tape reel 50, a second tape reel 52, a first idler wrap guide 54, a second idler wrap guide 56, a tape guide 58, and a storage tape 60. As described in greater detail below, the first and second tape reels 50, 52, the idler wrap guides 54, 56, and the tape guide 58 are secured to an interior surface 62 of the base plate 38, and define a tape path for the storage tape 60.

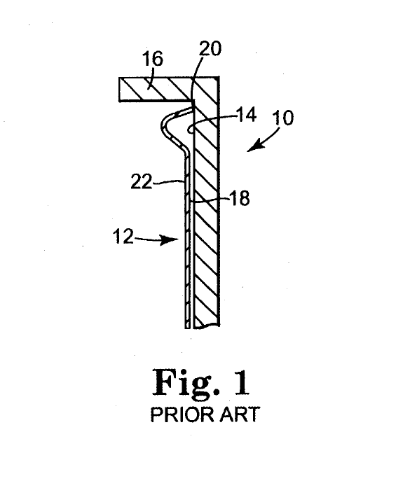

In a preferred embodiment, the base plate 38 is made of a rigid material, such as aluminum. The base plate 38 is sized to nest within the first housing section 34 (FIG. 1), and defines a head access recess 64 sized to correspond with the head access window 42 (referenced generally in FIG. 3).

The tape reels 50, 52 are virtually identical and are positioned to rotate relative to the base plate 38 about respective hub pins (not shown). As is known in the art, each of the first and second tape reels 50, 52 includes opposing reel flanges 70 (a bottom one of which is shown in FIG. 3) and a central hub 72. The opposing reel flanges 70 are spaced along the hub 72 in accordance with a width of the storage tape 60. The storage tape 60 wraps around an outer circumference of the hub 72, laterally constrained by the opposing reel flanges 70.

The idler wrap guides 54, 56 are disposed upon the base plate 38 and serve to increase a length of the tape path that in turn reduces lateral tape motion at the head access window 42. In one embodiment, the idler wrap guides 54, 56 are positioned to provide a tape path of the storage tape 60 between the tape reels 50, 52 and the tape guide 58. Alternatively, a number of other guide components can be employed for the idler tape wrap guides 54, 56.

The storage tape 60 is preferably a magnetic tape of a type commonly known in the art. For example, the storage tape 60 may consist of a balanced polyethylene naphthalate-(PEN) based material coated on one side with a layer of magnetic material dispersed within a suitable binder system, and on the other side with a conductive material dispersed within a suitable binder system. Acceptable magnetic storage tape is available from Imation Corp., of Saint Paul, Minn.

As illustrated in FIG. 3, the above components combine to define a tape path for the storage tape 60. In particular, the storage tape 60 extends from the first tape reel 50 and articulates about the first idler wrap guide 54 and to the tape guide 58. The tape guide 58 extends the storage tape 60 across the head access recess 64 (and thus the head access window 42). The storage tape 60 extends from the tape guide 58 to the second idler wrap guide 56 and, in turn, to the second tape reel 52.

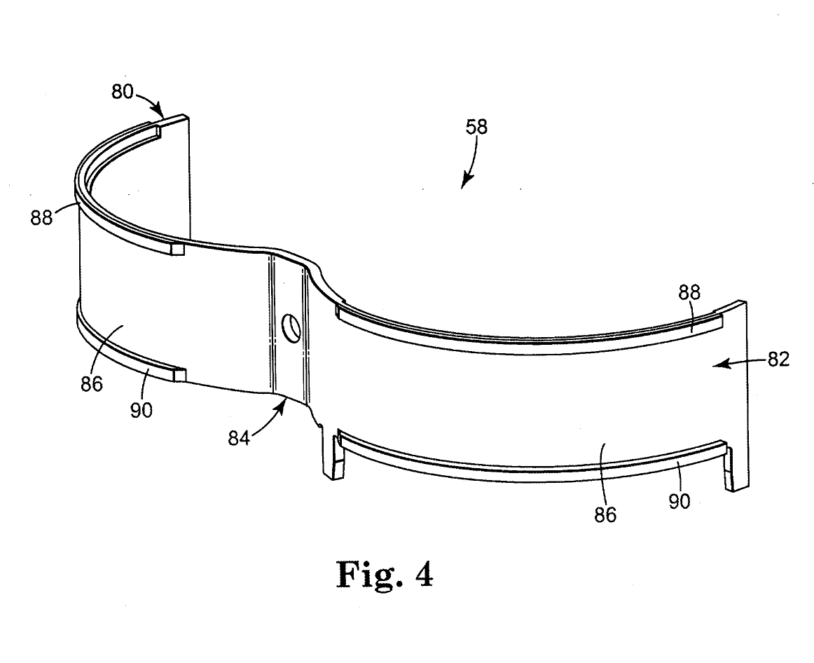

With the above construction in mind, the tape guide 58 is configured to guide the storage tape 60 across the head access window 42 and minimize lateral movement of the storage tape 60. More particularly, and with reference to FIG. 4, the tape guide 58 includes corner guide portions 80, 82 positioned at opposite sides of a central region 84. The corner guide portions 80, 82 are preferably identical, each defining a longitudinally curved or arcuate tape contact face 86, a top guide flange 88, and a bottom guide flange 90. The tape contact face 86 is laterally planar, and guides longitudinal movement of the storage tape 60 (FIG. 3) across the tape guide 58. The top and bottom guide flanges 88, 90 are provided to limit undesired lateral movement of the storage tape 60 as it traverses the tape contact face 86. In this regard, at least a portion of one or both of the guide flanges 88, 90 is adapted to minimize the opportunity for micro-buckling of the storage tape 60 upon lateral movement toward the respective flange 88 or 90.

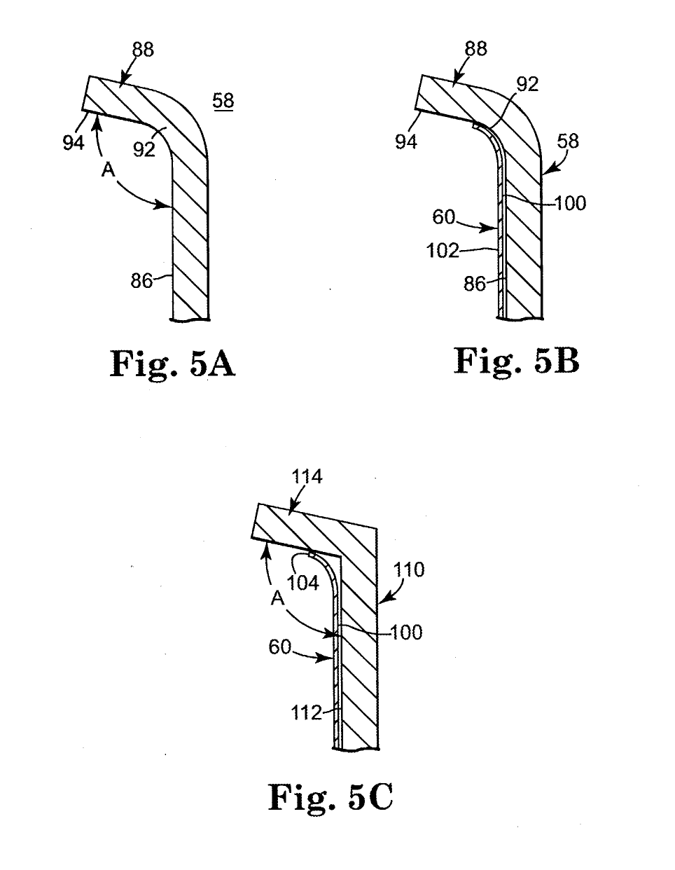

In particular, and with reference to FIG. 5A, one embodiment of the tape guide flange 88 in conjunction with a portion of the tape contact face 86 is shown. Extension of the guide flange 88 relative to the tape contact face 86 (that is otherwise laterally planar) defines a guide angle A selected to promote desired movement of the storage tape 60 (FIG. 4) along the guide flange 88, and in turn toward the bottom guide flange 90 (FIG. 4) as described below. In particular, the guide angle A is greater than 90°, preferably not less than 92°, and more preferably not less than 94°. In one embodiment, the guide angle A is in the range of 91°-100°, but can be greater than 100°. By forming the guide angle A to be greater than 90°, a “hard stop” to lateral tape movement, as otherwise presented with conventional tape guide configurations, is eliminated. It has been found that a guide angle A greater than 94° produces a guiding force on the storage tape 60 with minimal edge wear.

In addition to the guide angle A, with the one embodiment of FIG. 5A, the guide flange 88 defines a gradual curve as it extends from the tape contact face 86. In particular, the guide flange 88 can be defined as including a trailing section 92 and a leading section 94. The trailing section 92 extends from the tape contact face 86, and the leading section 94 extends from the trailing section 92. In this regard, the trailing section 92 is curved or arcuate in transverse cross-section, for example defining a parabolic curvature. In one embodiment, the parabolic shape is defined by the equation:

y=ax²,

where:

a=real-value constant,

y=distance of the top flange from the tape contact face, and

x=distance of the top flange from the bottom flange.

Alternatively, other functional relationships can be employed or a simple radius can be defined. Regardless, the leading section 94 is preferably linear in transverse cross-section, with a curvature of the trailing section 92 orienting the leading section 94 relative to the tape contact face 86 in a manner that defines the desired guide angle A.

During use, and with reference to FIG. 5B, the storage tape 60 is longitudinally driven along the tape contact face 86. In this regard, the storage tape 60 defines a back side 100, a front side 102, and opposing edges 104 (one of which is shown in FIG. 5B). The back side 100 moves longitudinally along the tape contact face 86. From time-to-time, the storage tape 60 may be subjected to a force that causes or imparts lateral movement. For example, the storage tape 60 can be forced to move laterally upwardly (relative to the orientation of FIG. 5B), such that the edge 104 approaches the guide flange 88 (it being noted that FIG. 5B illustrates a lateral positioning of the storage tape 60 following application of this lateral movement-causing force). The guide angle A in combination with the curved trailing section 92 causes the edge 104 to move outwardly or away from the tape contact face 86, such that the back side 100 adjacent the edge 104 interfaces or “rides” along the guide flange 88 (e.g., the back side 100 moves laterally and longitudinally along the guide flange 88). This action, in turn, imparts a lateral force onto the storage tape 60 opposite the initial direction of lateral tape travel (e.g., relative to FIG. 5B, a downward force is created by the guide flange 88/storage tape 60 interaction). Thus, the guide flange 88 serves to reduce lateral movement, and directs the storage tape 60 to a desired lateral position.

The guide flange 88 of the present invention prevents the tape edge 104 from interacting with a corner that might otherwise cause edge wear. The preferred curved nature of the trailing section 92 similarly causes the back side 100 to ride along the guide flange 88, rather than the edge 104 itself. Thus, the guiding forces provided by the guide flange 88 of the present invention are spread over a larger area (as opposed to being imparted solely on the edge 104), providing improved wear performance. As a result of this increased surface area interface, the guide flange 88 configuration of the present invention provides a guide flange reaction force that is actually greater as compared to the “standard” perpendicular guide flange extension.

The guide flange 88 of FIGS. 5A and 5B is but one acceptable configuration capable of directing outward movement of the storage tape edge 104 relative to the tape contact face 86. For example, FIG. 5C illustrates a portion of an alternative embodiment tape guide 110 in conjunction with the storage tape 60. The tape guide 110 includes a tape contact face 112 and a guide flange 114. Extension of the guide flange 114 relative to the tape contact face 112 defines the guide angle A. Once again, the guide angle A is, unlike conventional designs, greater than 90°, preferably not less than 92°, and more preferably not less than 94°. As compared to the tape guide 58 of FIGS. 5A and 5B, however, the guide flange 114 does not include a curved section. Instead, the guide flange 114 is linear in transverse cross-section. By providing the preferred guide angle A, however, the tape guide 110 of FIG. 5C again directs outward movement of the tape edge 104 relative to the tape contact face 112 with lateral movement of the storage tape 60 as a whole. Once again, the back side 100 of the storage tape 60 is preferably directed to “ride” along the guide flange 114.

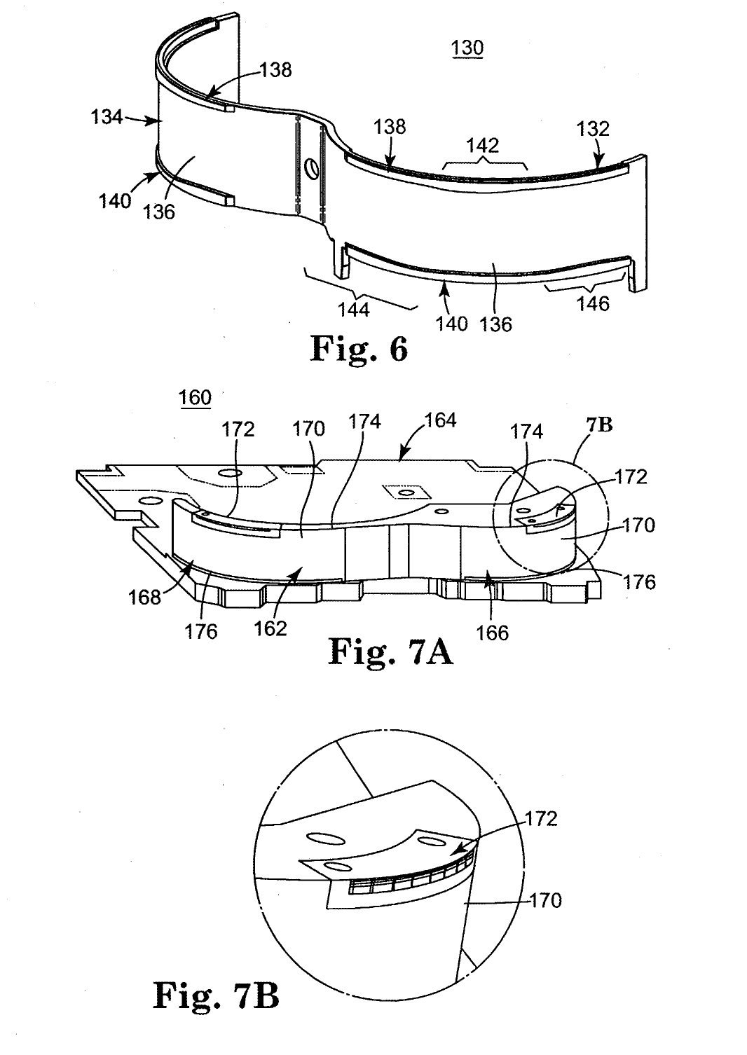

The guide flange configuration of the present invention can be provided in a variety of manners relative to a particular tape guide. For example, an entirety of the guide flange can form the desired guide angle A, or a portion thereof Further, both of the top and bottom guide flanges 88, 90 (FIG. 3) can provide the desired guide angle A. Alternatively, only one of the top or bottom guide flanges 88, 90 can be so configured. For example, FIG. 6 illustrates an alternative embodiment tape guide 130. Similar to the tape guide 58 of FIG. 4, the tape guide 130 includes opposing corner guide portions 132, 134 each including a tape contact face 136, a top flange 138, and a bottom flange 140. The top flange 138 defines an offset region 142 that extends toward the bottom flange 140. Similarly, the bottom flange 140 defines first and second offset regions 144, 146, each of which extend toward the top flange 138. A lateral space between the offset region 142 of the top flange 138 relative to the offset regions 144, 146 of the bottom flange 140 is preferably less than a width of the storage tape (not shown) to dictate a desired lateral position of the storage tape.

In addition, the top flange 138 in the offset region 142 is configured similar to that shown in FIGS. 5A or 5C. In particular, the top flange 138 in the offset region 142 extends at the guide angle A (FIGS. 5A and 5C) such that the offset region 142 directs the corresponding tape edge (not shown) to move outwardly relative to the tape contact face 136 upon lateral movement toward the top flange 138. With the embodiment of FIG. 6, the bottom flange 140, including the offset regions 144, 146, conform with the conventional technique whereby extension of the flange 140 relative to the tape contact face 136 defines a 90° angle. Alternatively, the offset regions 144, 146 of the bottom flange 140 can also be configured to provide the desired guide angle A that is greater than 90° and/or an entirety of one or both of the top and bottom flanges 138, 140 can provide the desired guide angle A.

FIG. 7A illustrates a portion of a data storage tape cartridge 160 incorporating an alternative embodiment tape guide 162 in accordance with the present invention. The tape guide 162 is assembled to a base plate 164, and includes opposing corner guide portions 166, 168. Each of the corner guide portions 166, 168 defines a longitudinally curved tape contact face 170. Further, each of the corner guide portions 166, 168 includes a top flange 172 that extends generally outwardly from a top side 174 of the tape contact face 170 along a portion of a longitudinal length thereof, and a bottom flange 176. In one embodiment, the top flange 172 is provided as a separate component that is assembled to the tape guide 162, whereas the bottom flange 176 is integrally formed. Alternatively, the top flange 172 can be integrally formed.

With additional references to FIG. 7B, extension of the top flange 172 relative to the tape contact face 170 defines the previously described guide angle A (not referenced in FIGS. 7A and 7B, but shown generally in FIGS. 5A and 5C) that is greater than 90°. Further, transition of the top flange 172 away from the tape contact face 170 is curved in transverse cross-section. Once again, this configuration directs a corresponding edge of the storage tape (not shown in FIGS. 7A and 7B) to move outwardly or away from the tape contact face 170 along the top flange 172, providing a gentle guiding surface. Interface with the tape flange 172 causes the storage tape to move laterally toward the bottom flange 176 that otherwise defines a standard 90° corner and thus, provides a transverse tape path limitation opposite the top flange 172. The profile of the top flange 172 can be varied in terms of length, curvature, depth, and width to optimize tape motion performance. While the top flange 172 preferably extends along only a portion of the corresponding corner guide portion 166 or 168 so as to limit stress/strain in the storage tape (and thus avoid permanent deformation) and allow the storage tape to return to the “in-plane” state prior to passing in front of the read/write head (not shown), the top flange 172 can extend along an entirety of the corner guide portions 166 or 168. Further, the tape guide 162 and, in particular, the tape contact face 170, can be tilted or skewed relative to the base plate 164 to counteract potential variation in tape tension across a width of the tape contact face 170.

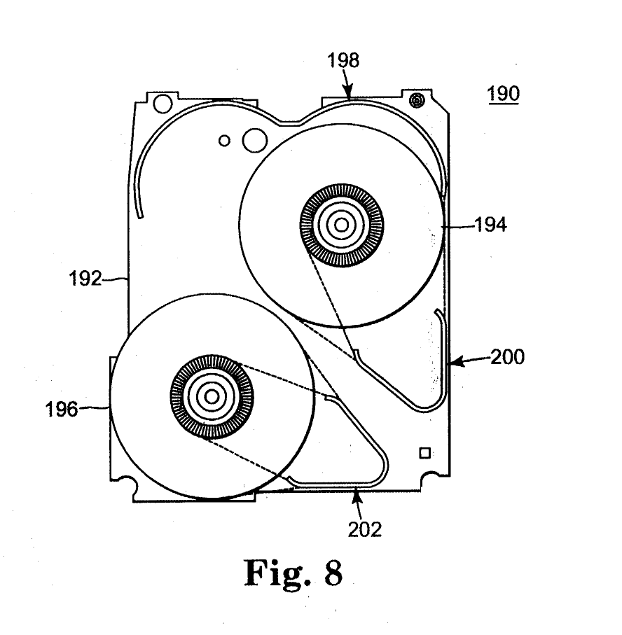

In addition, or as an alternative, to providing the preferred guide flange configuration as part of a tape guide component otherwise positioned adjacent the head access window, other guide components associated with a data storage tape cartridge can include the guide flange of the present invention. For example, FIG. 8 illustrates a portion of an alternative embodiment data storage tape cartridge 190 including a base plate 192 maintaining tape reels 194 and 196, a primary tape guide 198, a first idler tape guide 200 and a second idler tape guide 202. The primary guide 198 can be configured in accordance with previous embodiments or can have a conventional design. Regardless, the idler tape guides 200, 202 replace the pin-type idler bearings conventionally employed (such as the idlers 54, 56 shown in FIG. 3). By way of reference, tape guiding is normally not provided at the idler locations, as introducing an edge guide at these locations potentially creates durability issues due to the close proximity to the tape reels 194, 196 and high edge forces from spool-induced tape motions. The data storage tape cartridge 190 of FIG. 8 overcomes these concerns by providing the idler tape guides 200, 202 with a flange configuration in accordance with the present invention.

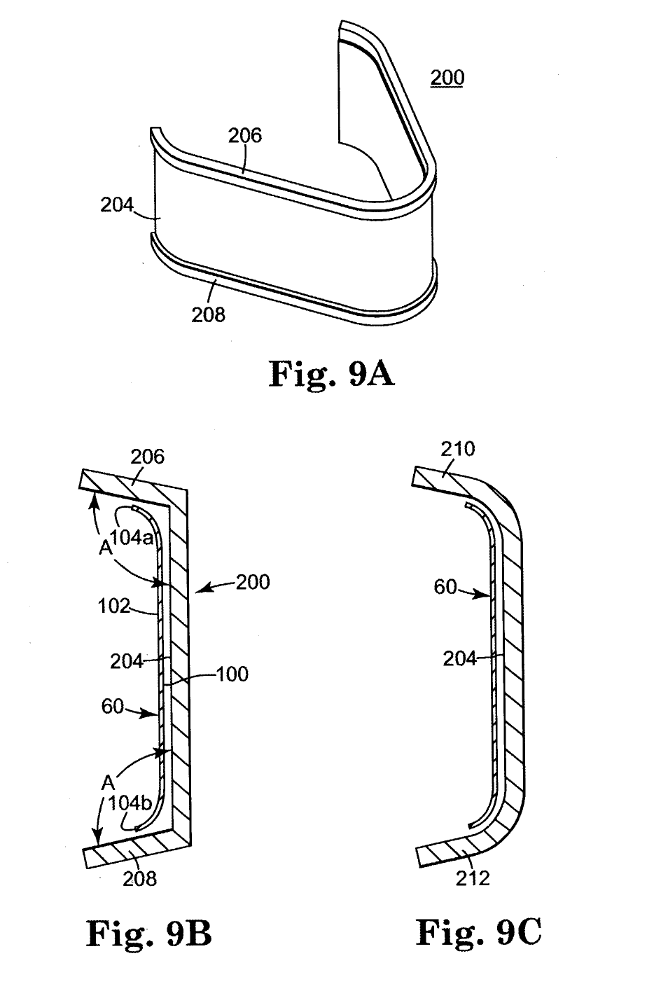

In particular, FIG. 9A illustrates the first idler tape guide 200 in greater detail, it being understood that the second idler tape guide 202 (FIG. 8) is preferably similarly configured. The idler tape guide 200 includes a tape contact face 204, a top flange 206, and a bottom flange 208. The tape contact face 204 is laterally planar, with the top and bottom flanges 206, 208 projecting from the tape contact face 204 at opposite sides thereof With this in mind, extension of the top and bottom flanges 206, 208 relative to the tape contact face 204 provides a guide angle that directs outward movement of a corresponding tape edge.

For example, FIG. 9B illustrates a portion of the idler tape guide 200 in conjunction with the storage tape 60. Once again the storage tape 60 includes the back side 100, the front side 102, and opposing edges 104a, 104b. A width of the tape contact face 204 (as defined by a distance between the top and bottom flanges 206, 208 at a point of extension from the tape contact face 204) is less than a width of the storage tape 60. As such, the opposing tape edges 104a, 104b are consistently positioned against the top and bottom flanges 206, 208, respectively. In this regard, extension of the top flange 206 relative to the tape contact face 204, as well as extension of the bottom flange 208 relative to the tape contact face 204 defines the guide angle A. Once again, the guide angle A is greater than 90°, preferably not less than 92°, more preferably not less than 94°. This orientation of the top and bottom flanges 206, 208 relative to the tape contact face 204 directs the respective tape edges 104a, 104b to extend outwardly relative to the tape contact face 204, with the back side 100 of the storage tape 60 interfacing against, or “riding” along, the top and bottom flanges 206, 208, as opposed to direct contact between the flange 206 or 208 and the corresponding tape edge 104a or 104b. In an alternative embodiment, and with reference to FIG. 9C, top and bottom flanges 210, 212 can define a curved geometry in transverse cross-section with extension from the tape contact face 204 as previously described. While the top and bottom flanges 206, 208 are preferably identical in orientation relative to the tape contact face 204, variations between the flanges 206, 208 are also acceptable. For example, the idler guide can be a drawn metal component having a conventionally-formed bottom flange (such as shown in U.S. Pat. No. 5,772,143) to which the top flange 206 in accordance with the present invention is added.

The above-described idler tape guide 200, 202 minimizes the opportunity for tape edge wear due to the preferred guide angle defined by the corresponding flanges 206, 208 relative to the tape contact face 204. Returning to FIG. 8, by providing tape guidance at the idler locations, incoming lateral tape motion relative to the primary tape guide 198 is reduced. Further, winding of the storage tape (not shown) on the reels 194, 196 is controlled, potentially minimizing winding complications, such as scatterwinds, popped strands, and flange hits. In fact, if the idler tape guides 200, 202 sufficiently control winding of the storage tape about the reels 194, 196, the tape reel flanges 214 may be eliminated.

While the present invention has been described with respect to one or more tape guide components within a data storage tape cartridge, other tape guide applications are equally acceptable. For example, one or more internal components of a single reel data storage tape cartridge can be provided with the guide flange configuration of the present invention. Further, while an elongated tape guide component has been illustrated, separate corner guides can be employed, one or both of which include a guide flange in accordance with the present invention. Alternatively or in addition, the tape guide component in accordance with the present invention can be provided within, or as part of, the tape drive or other tape transport system component.

The tape guide component and related method of use of the present invention provides a marked improvement over previous designs. By orienting the tape guide flange to define an angle greater than 90° relative to a laterally planar tape contact face directs outward movement of the storage tape edge relative to the tape contact face. This, in turn, minimizes the opportunity for micro-buckling or other overt wear-causing actions. Further, higher guiding forces are provided as compared to conventional tape guide flange designs.

Although the present invention has been described with reference to preferred embodiments, workers skilled in the art will recognize that changes can be made in form and detail without departing from the spirit and scope of the present invention.

What is claimed is:

1. A data storage tape cartridge comprising:
a housing;
at least one tape reel rotatably disposed within the housing;
a storage tape extending from the tape reel along a tape path; and
a tape guide positioned within the housing and defining a portion of the tape path, the tape guide including a tape contact face and at least one guide flange, wherein an extension of the guide flange relative to the tape contact face defines a guide angle that is not less than 90°.

2. The data storage tape cartridge of claim 1, wherein the guide angle is greater not less than 94°.

3. The data storage tape cartridge of claim 1, wherein the storage tape includes a back side, a front side, and opposing edges, the tape extending such that the back side interfaces with the tape contact surface, and further wherein the guide flange is configured to facilitate movement of the back side along the guide flange with lateral movement of the storage tape relative to the tape contact face.

4. The data storage tape cartridge of claim 1, wherein the guide flange includes a trailing section extending from the tape contact face and a leading section extending from the trailing section, and further wherein the guide angle is defined by an orientation of the leading section relative to the tape contact face.

5. The data storage tape cartridge of claim 4, wherein the trailing section is curved in transverse cross-section.

6. The data storage tape cartridge of claim 5, wherein the trailing section is arcuate in transverse cross-section.

7. The data storage tape cartridge of claim 4, wherein the trailing section is linear in transverse cross-section, and further wherein orientation of the trailing section relative to the contact face defines the angle guide.

8. The data storage tape cartridge of claim 1, wherein the housing defines a window for accessing the storage tape, and further wherein the tape guide is positioned adjacent the window such that the tape contact face guides the storage tape across the window.

9. The data storage tape cartridge of claim 1, further comprising:
a primary guide positioned adjacent a window formed in the housing for accessing the storage tape;
wherein the tape guide is spaced from the window, along a tape path between the primary guide and the tape reel, such that the tape guide is an idler wrap guide.

10. The data storage tape cartridge of claim 1, further comprising:
a base plate disposed within the housing and having a top surface from which the tape reel and the tape guide extend;
wherein the guide flange is a top flange located opposite the base plate.

11. The data storage tape cartridge of claim 10, wherein the tape guide further includes a bottom flange opposite the top flange such that upon final assembly, the bottom flange is adjacent the base plate.

12. The data storage tape cartridge of claim 11, wherein extension of the bottom flange relative to the tape contact face defines a 90° angle.

13. The data storage tape cartridge of claim 11, wherein extension of the bottom flange relative to the tape contact face defines an angle of not less than 90°.

14. A method of guiding a storage tape in a tape transport system, the storage tape including a front side, a back side, and opposing top and bottom edges, the method comprising:
extending the storage tape from a tape reel along a tape path defined in part by a tape guide having a tape contact face and a top flange;
directing the storage tape in a longitudinal fashion along the tape contact face, wherein the storage tape is periodically subjected to a force that causes lateral movement of the storage tape relative to the tape contact face; and
directing the top edge of the storage tape, otherwise interfacing with the tape guide, to move away from the tape contact face with lateral movement of the storage tape via interaction with the top flange.

15. The method of claim 14, wherein directing the top edge to move away from the tape contact face includes directing a portion of the back side of the storage tape to ride along the top flange.

16. The method of claim 14, wherein directing the top edge to move away from the tape contact face is characterized by the top edge not contacting the top flange.

17. The method of claim 14, wherein directing the top edge to move away from the tape contact face is characterized by the top edge not interfacing with a 90° corner.

18. The method of claim 15, wherein the method of guiding occurs within the data storage tape cartridge.

19. A tape guide for use in a tape transport system, the tape guide comprising:
a tape contact face; and
a guide flange extending from one side of the tape contact face, wherein at least a portion of an extension of the guide flange relative to the tape contact face defines an angle of not less than 90°.

20. The tape guide of claim 19, wherein the tape guide is adapted for use in a data storage tape cartridge.
